(19) United States
(12) Patent Application Publication
(10) Pub. No.: US 2026/0283406 A1
(43) Pub. Date: Sep. 24, 2026

(54) ELECTRIC CORN STRIPPING APPARATUS WITH SELF-ADAPTIVE CUTTING MECHANISM

(71) Applicant: Valentina Zhang, Katy, TX (US)

(72) Inventor: Valentina Zhang, Katy, TX (US)

(21) Appl. No.: 19/683,441

(22) Filed: May 20, 2026

Related U.S. Application Data
(62) Division of application No. 18/960,430, filed on Nov. 26, 2024.

(51) Int. Cl. A47J 43/046; A47J 17/02; A47J 43/07

(52) U.S. Cl. CPC A47J 43/046; A47J 17/02; A47J 43/0794

(57) ABSTRACT

An apparatus for separating corn kernels from a cob includes a motor unit, a food container, a kernel stripper, a safety cover, and a cob handle. The kernel stripper features a self-adaptive cylindrical blade set with curved blades and springs configured to adjust their diameter automatically based on cob size. The kernel stripper is coupled to the motor unit via a rotor connector and a rotor adapter containing a built-in compressible safety switch. The safety cover is provided with a circular aperture to allow insertion of a cob while preventing manual access to the rotating stripper. The cob handle includes a guide pin with a corkscrew and a protection edge configured to interface with the safety cover. The apparatus provides a safe and efficient system for kernel removal that accommodates varying cob shapes and sizes.

### CROSS-REFERENCE TO RELATED APPLICATIONS

This application is a divisional of U.S. patent application Ser. No. 18/960,430, filed Nov. 26, 2024, the entire contents of which are incorporated herein by reference.

### BACKGROUND

### 1. Field of Technology

Method and apparatus are disclosed for small appliances in kitchens or restaurants, particularly a self-adaptive electric corn stripper which incorporates an electric motor-driven kernel stripper with a cylindrical blade set. Capable of adjusting the blade diameter according to the diameter of the cob automatically, it is utilized to effectively, efficiently, and safely separate corn kernels from a cob without losing parts of kernels or getting a cob stuck during separation.

### 2. Description of Prior Art

Sweet corn is a prevalent food. To prepare it in kitchens, restaurants, or preserve it in cans for future use, there is a need to effectively, quickly, and safely separate corn kernels from a cob. Over the years, a variety of methods and tools have been developed to separate the corn kernels from a cob besides using a knife. There are two types of stripping techniques, depending on whether the ears of corn are dry or wet. When an ear of corn is dry, a pair of teeth (U.S. Pat. No. 1,663,365) or six V-shaped ribs (U.S. Pat. No. 1,528,437) or four cylindrical spikes (U.S. Pat. No. 2,626,611) within a cutting head were utilized to strip the kernels from a cob perpendicularly to its axis. When an ear of corn is wet, an arch-shaped blade (US 20190264661) or a fixed circular blade (US 20080066316, U.S. Pat. No. 1,030,424) scrapes or cuts the corn kernels from a cob along its axis. However, those methods and tools have issues regarding effectiveness, efficiency, and safety. For example, cutting corn kernels from the cob with a knife is not only inefficient and unsafe but also hard to accomplish, especially when a cooked corn ear is still hot. Using tools with a fixed arch-shaped blade or a fixed circular blade usually results in parts of corn kernels getting wasted or a cob getting stuck into the circular blade during stripping, as corn cobs are not the right cylinders with the same diameter along the axis. On the contrary, corn cobs are shaped more like cones, and some are even curved along the axis. Furthermore, different ears of corn usually have different shapes and sizes. So do the corn cobs. All those varieties in shape and size are the main reason why a fixed arch-shaped blade or a fixed cylindrical blade with a predetermined diameter would never perfectly fit the cob surface even for a single ear of corn, let alone for all ears of corn. When the diameter of a cob is smaller than that of a fixed blade, some parts of kernels are left on the cob and get wasted. When the diameter of a cob is larger than that of a fixed blade, the cob does not fit or gets stuck into the fixed blade during the stripping process. Moreover, tools using teeth, ribs, or cylindrical spikes for stripping the dry kernels would not be applicable for the wet kernels, as the soft kernels would be smashed by the teeth, ribs, or spikes of the tools. Furthermore, trying to attach either a corn stripper head or a corn cob to a high-speed handheld drill also raises safety concerns, as corn kernels would splash in all directions. Hence, it is not an effective and safe work environment. That is why gloves must be worn to hold the cob by hand and safety glasses are recommended to provide eye protection.

From the description above, it is apparent that all methods and apparatus of prior art have more or less limitations. Therefore, there is a need to develop a method and an apparatus that can overcome those limitations so that fresh corn kernels can be effectively, efficiently, and safely removed from a cob. The method and apparatus described in this invention can automatically adjust the diameter of a blade set inside a kernel stripper so that the blades can perfectly fit the cob surfaces for all ears of corn to reduce the kernel waste and to avoid a cob being unfit or stuck into the blade set during operation. Furthermore, the stripping process is accelerated safely by using an electric motor to drive the kernel stripper in a regulated speed range. Moreover, hygiene and safety concerns are addressed by using food-graded material and by providing multi-layer safety protections.

### SUMMARY

This summary is provided to introduce a selection of concepts in a simplified form that are further described below in the detailed description. It is not intended to identify key features or essential features of the claimed subject matter, nor is it intended to be used as an aid in determining the scope of the claimed subject matter.

Disclosed herein are methods and apparatus to effectively, efficiently, and safely separate kernels from cobs by using multiple blades with springs to form a self-adaptive cylindrical blade set inside a stripper, which is driven by an electric motor unit through a rotor connector and rotates in a regulated speed range.

According to one of the embodiments in this disclosure, a method for separating the corn kernels from a cob includes a plurality of steps. First, plug the power cord of a self-adaptive electric corn stripper into an electric socket. Secondly, insert the guide pin and rotate the corkscrew of the cob handle clockwise into the center of the tail end of an ear of corn. Thirdly, turn on the power switch and then insert the ear of corn vertically into the center of the self-adaptive cylindrical blade set inside the stripper and press it down by using the cob handle so that the motor starts rotating. Fourthly, continue pressing it down until all kernels are separated from the cob, which can be indicated by observing the safety edge of the cob handle touch the top surface of the safety cover, stop pressing down and the motor stops rotating automatically. Fifthly, retrieve the cob by pulling the cob handle straight upward with one hand while the other hand is holding the apparatus. Sixthly, remove the stripped cob from the cob handle and attach a new ear of corn, and repeat above steps 2-6 until the food container is full or the job is done. Seventhly, turn off the power switch, unplug the electric cord from the socket, remove both the safety cover and the stripper, and collect the kernels from the food container.

According to one of the embodiments in this disclosure, the apparatus of a self-adaptive electric corn stripper consists of a motor unit with a rotor adaptor, a food container, a kernel stripper, a safety cover, and a cob handle. The rotor adaptor also acts as another layer of safety protection besides the power switch, as it has a safety switch below the rotor adapter, which turns on only when the rotor adaptor is pressed down. The motor will stop rotating as soon as there is no pressure on the rotor adapter. This feature remains even when the power switch is on, providing extra safety protection during operation. The food container is a cylindrical shell-shaped storage, which allows the rotor adaptor to pass through it and attach to the stripper. There is a lock/unlock mechanism between the container and the motor unit so that when assembled, the container does not move or rotate. The kernel stripper is also a cylindrical shell-shaped barrel with a hexagonal rotor connector at the bottom. There are multiple curved blades with springs to form a self-adaptive cylindrical blade set inside the stripper, which is used to cut kernels from a cob when rotating. The diameter of the circular blade can automatically adjust to fit the cob diameter of an ear of corn during cutting, as the cob is harder than the wet kernel. When the cob gets larger in diameter along the axis during stripping, the springs behind the blades are pressed to form a larger diameter for the circular blade set. On the contrary, when the cob gets smaller along the axis, the springs behind the blades relax a little, forming a smaller diameter for the cylindrical blade set. There are a few holes on the lower side wall and at the bottom of the stripper which allow the stripped kernels to fall into the food container. A safety cover is designed for the food container to prevent a possible hand injury by accidentally touching the rotating stripper during the operation. The safety cover can be locked with the food container so that the cover does not move or rotate during operation. There is also a circular hole in the center of the safety cover. The diameter of the circular hole is smaller than the outer diameter of the kernel stripper (e.g., the diameter can be the same as the inner diameter of the kernel stripper). In this way, an ear of corn can get into the kernel stripper without any obstacle, and the kernel stripper can be protected from touching during operation and be held in place by the safety cover while retrieving the cob after the kernels are stripped. To add another layer of safety, a cob handle with a safety edge is designed to hold the corn cob in place by a specially designed pin with a corkscrew during the operation so that a person's hand will never have to touch the rotating kernel stripper. This would help ensure safety even if the safety switch below the rotor adaptor and the power switch on the side of the motor unit failed at any time during the operation.

In some of the embodiments, there is a set of curved blades (e.g., three or four blades) with springs that form a cylindrical blade set capable of changing its diameter in different ranges (e.g., from 30 mm to 40 mm for the sweet corn, from 34 mm to 44 mm for the dent corn).

In some of the embodiments, the power can be 110-120V (60 Hz) AC or 220V-240V (50 Hz) AC from electrical outlets at home, or 5V DC from the port of a USB wall charger, or 12V, 18V, 24V DC from rechargeable batteries.

The use of rechargeable batteries to provide power for the corn stripper enables the electric corn stripper to be more portable and work in places where AC power is not readily available.

### BRIEF DESCRIPTION OF THE DRAWINGS

The present invention can be readily understood by considering the following detailed description in conjunction with the accompanying drawings.

FIG. 1 illustrates an exemplary configuration of a self-adaptive electric corn stripper having a motor unit (100), a food container (200), a kernel stripper (300), a safety cover (400), and a cob handle (500).

FIG. 2 illustrates a 3-D view of an exemplary motor unit (100) having a power cord (101), a power base (102), a power switch (103), a safety switch (104), a female rotor adapter (105), and two locks (106A, 106B) for the motor unit and the food container.

FIG. 3 shows a 3-D view of an exemplary food container (200) having a cylindrical fitting (201) onto the motor unit, two locks (202A and 202B), an inner cylindric wall (203), an outer cylindrical wall (204), a handle (205) and the top edge (206) used by two locks of the safety cover.

FIG. 4 shows a 3-D view of an exemplary kernel stripper (300) having a male hexagonal connector (301), and multiple holes (302) on the side wall and at the bottom of the kernel stripper. The stripper body (303) is further separated into an upper section (303A) and a lower section (303B). A blade set (304) is inside the upper section (303A).

FIG. 5 shows an exemplary configuration of the upper section of the stripper in FIG. 5A with a blade set in FIG. 5B, which has three curved blades with springs shown in FIG. 5C or four curved blades with springs shown in FIG. 5D.

FIG. 6 shows an exemplary configuration of the safety cover (400) having a circular opening (403) on the top and two locks (401A and 401B) at the bottom to secure it with the top edge of the food container (200).

FIG. 7 shows a 3-D view of an exemplary cob handle (500) having a specially designed guide pin with a corkscrew (501) to attach the cob of an ear of corn, an extension rod (502), a circular protection edge (503), and a handle (504).

FIG. 8 is an exemplary workflow showing the steps of using the self-adaptive electric corn stripper to separate kernels from cobs.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the method and apparatus described herein. Examples are illustrated in the accompanying drawings. Similar or like reference numbers may be used in the drawings and may indicate similar or like elements.

The features described herein may be embodied in different forms and are not to be construed as being limited to the embodiments described herein. Rather, the embodiments described herein and depicted in the drawings have been provided so that this disclosure will be thorough and complete and will convey the full scope of the disclosure to one of ordinary skill in the art, who may readily recognize from the following description that alternative embodiments exist without departing from the general principles of the disclosure.

Therefore, the scope of the disclosure is defined not by the detailed description, but by the claims, their equivalents, and all variations within the scope of the claims, and their equivalents are to be construed as being included in the disclosure.

In this disclosure, unless otherwise noted, a self-adaptive electric corn stripper refers to an electric corn stripper which incorporates a set of curved blades (e.g., three or four blades) with springs to form a cylindrical blade set, which can adjust its diameter automatically according to the cob diameter of an ear of corn and is driven by an electric motor unit.

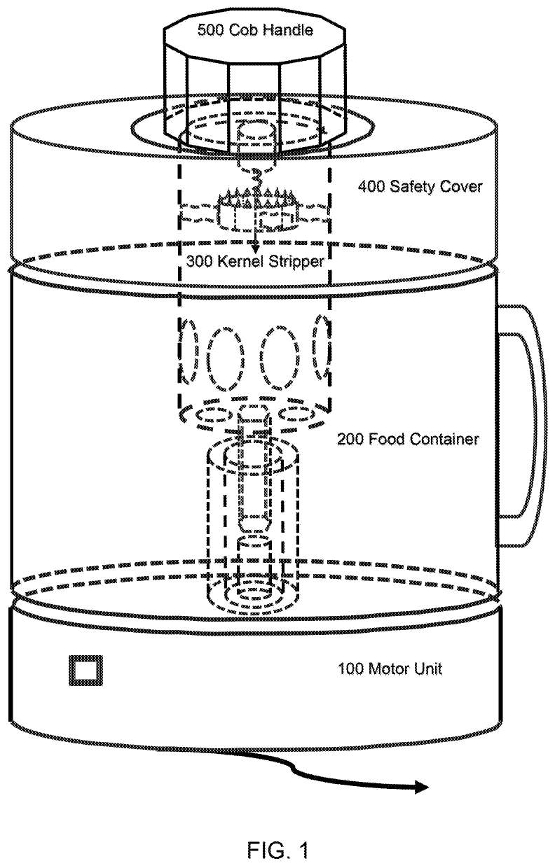

FIG. 1 illustrates an exemplary configuration of a self-adaptive electric corn stripper having a motor unit (100), a food container (200), a kernel stripper (300), a safety cover (400), and a cob handle (500). The motor unit is used to drive the kernel stripper which cuts the kernels from a cob while rotating. The food container is used to collect and temporarily store the stripped kernels. The safety cover protects a user's hands from touching the rotational kernel stripper and holds it in place while a stripped cob is retrieved from the circular blade set. The cob handle attaches an ear of corn using a specially designed guide pin with a corkscrew to press it down during the stripping process and retrieve the cob after the kernels are removed.

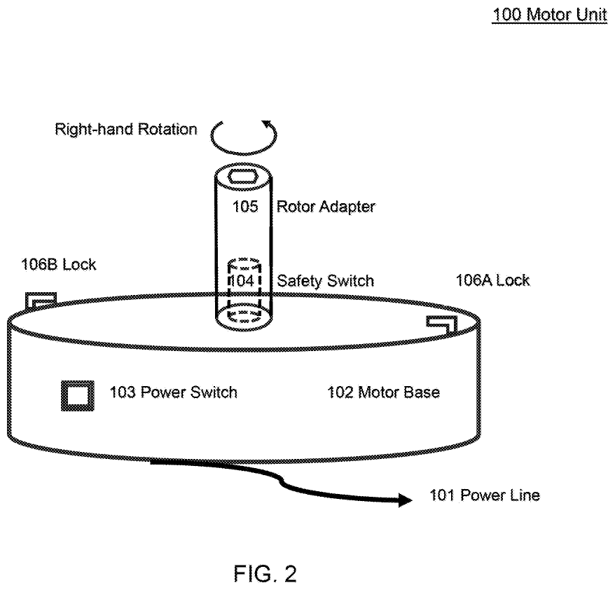

FIG. 2 illustrates a 3-D view of an exemplary motor unit (100) having a power cord (101), a power base (102), a power switch (103), a safety switch (104), a female rotor adapter (105), and two locks (106A, 106B). The power cord may be connected to an outlet with 110-120V (60 Hz) AC or 220V-240V (50 Hz) AC as an example to provide the power for the motor unit. In other embodiments, the power can be provided by 5V DC from the port of a USB wall charger, or by 12V, 18V, or 24V DC from a rechargeable battery (or a battery set), depending on the input of the motor and whether a voltage converter is used inside the motor unit. The power base incorporates a motor, a voltage converter, and an electronics system inside. The power switch is to turn the power on or off. The safety switch under the rotor adapter is for turning the motor on or off, based on whether there is pressure on the rotor adapter or the kernel stripper. For example, if the safety switch is pressed down about 3 mm by the rotor adaptor, the safety switch is on. When there is no pressure or when it is below the pre-set pressure level, or the switch is pressed down less than 3 mm, the switch is off. The pressure level can be set as a few pounds (e.g., 2 pounds). This design ensures the motor does not turn on when the cob is not pressed down for stripping, adding another layer of safety protection. The hexagonal female rotor adapter is used to connect to the male hexagonal rotor connector of the kernel stripper to drive the rotation of the kernel stripper. The right-hand rotation is shown as an example though the left-hand rotation also works. The rotation speed of the rotor adapter through the motor unit may be regulated in an appropriate range, e.g., from 1 to 20 revolutions per second (rps), depending on the safety and efficiency requirement of kernel stripping. The two locks lock the motor unit and the food container together so that the food container does not rotate or move during the operation.

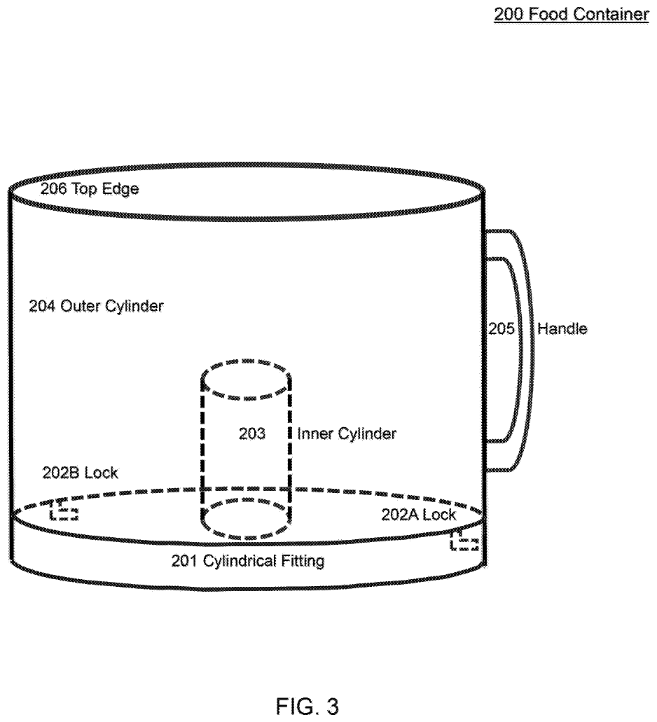

FIG. 3 shows a 3-D view of an exemplary food container (200) having a cylindrical fitting (201) to the motor unit, two locks (202A and 202B), an inner cylindrical wall (203), an outer cylindrical wall (204), a handle (205) and a top edge (206). The cylindrical fitting sets the food container onto the motor unit. The two locks (202A and 202B) are fitted into the two locks (101A and 101B) on the motor unit. The inner cylindrical wall allows the female rotor adapter of the motor unit to pass through. Together with the outer cylindrical wall, it forms a temporary kernel storage for the food container. The handle is designed as a convenient way to hold the food container while handling it. The top edge provides a ridge so the safety cover and the food container can be locked together. The food container can be made of glass, food-grade plastic (e.g., grade 2, 4, and 5), or food-grade stainless steel (e.g., 304, 316), etc.

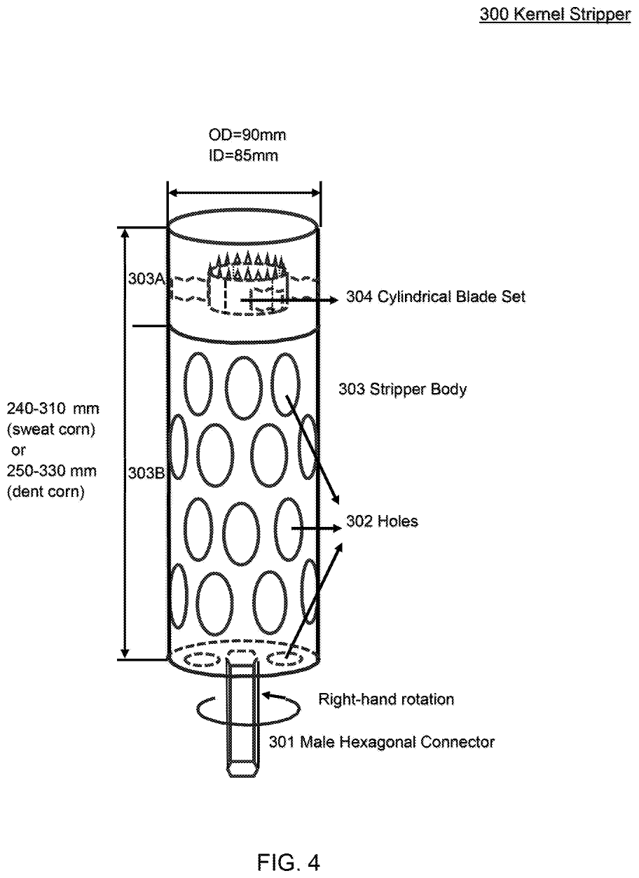

FIG. 4 shows a 3-D view of an exemplary kernel stripper (300) having a male hexagonal connector (301), and multiple holes (302) on the side wall and at the bottom of the kernel stripper. The stripper body (303) is further separated into an upper section (303A) and a lower section (303B). A cylindrical blade set (304) is inside the upper section (303A). An insert-and-lock design or adding threads on the two sections (303A and 303B) would join the two parts together. This design makes it easier to clean the kernel stripper after each use, as the blade set does not block the way toward the inside of the lower section. The male hexagonal rotor connector fits into the male rotor adaptor so that the motor drives the rotation of the kernel stripper. The multiple holes on the wall of the lower section and at the bottom of the stripper body allow kernels to fall into the food container whether the stripper is rotating or not. The right-hand rotation is shown as an example so that the rotation direction is the same as the rotor adapter in FIG. 2.

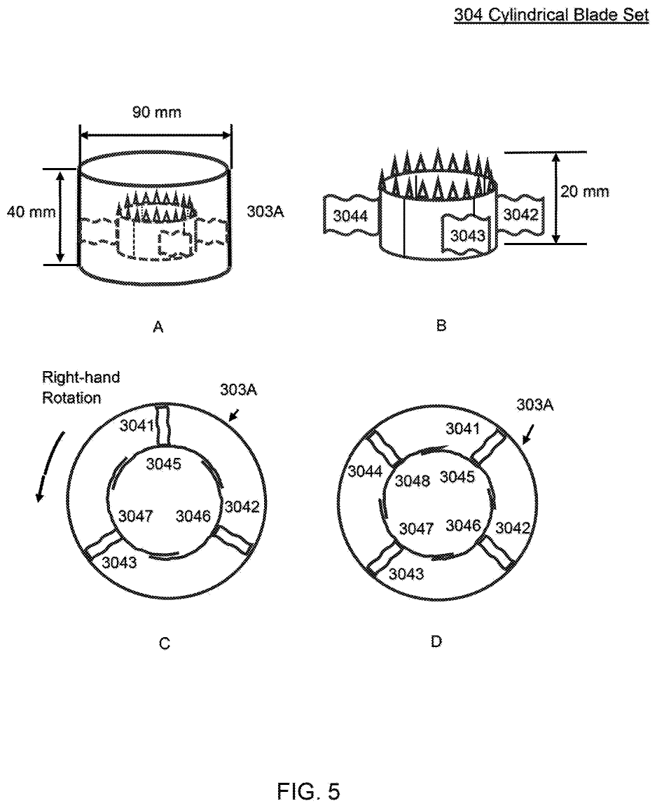

FIG. 5 shows an exemplary configuration of the upper section of the stripper (303A) in FIG. 5A and a blade set (304) in FIG. 5B. The top views of two exemplary configurations of feasible blade sets, consisting of three curved blades (3045, 3045, 3047) with three springs (3041, 3042, 3043), or four curved blades (3045, 3045, 3047, 3048) with four springs (3041, 3042, 3043, 3044), are shown in FIG. 5C and FIG. 5D, respectively. As shown in FIGS. 5A and 5B, the outside diameter and the height of the upper section of the stripper (303A) are selected as 90 mm and 40 mm. A cylindrical blade set with a height of 20 mm is placed in the middle of the upper section of the stripper. This design leaves a 10 mm distance from the top of the blade set to the top of the upper section of the stripper and 10 mm from the bottom of the blade set to the bottom of the upper section of the stripper, preventing hand injury during the handling. In FIGS. 5C and 5D, a right-hand rotation is shown as an example, which corresponds to whether one of the two ends of a curved blade is assembled inside or outside of the adjacent blades. The choice is consistent with the rotation direction of the rotor adapter and the kernel stripper, which also helps to reduce the friction of blades and improve cutting quality. The blades and springs may be made of material like a food-grade metal (e.g., titanium) or an alloy (e.g., 304, 316 stainless steel). The stripper body (303) may be made of material like a metal (e.g., titanium), an alloy (e.g., food-graded 304, 316 stainless steel), or a food-grade plastic (e.g., grade 2, 4, and 5). The male hexagonal connector may be made in a metal, alloy, chromium and nickel-plated steel, or ordinary stainless steel as it does not have contact with the food.

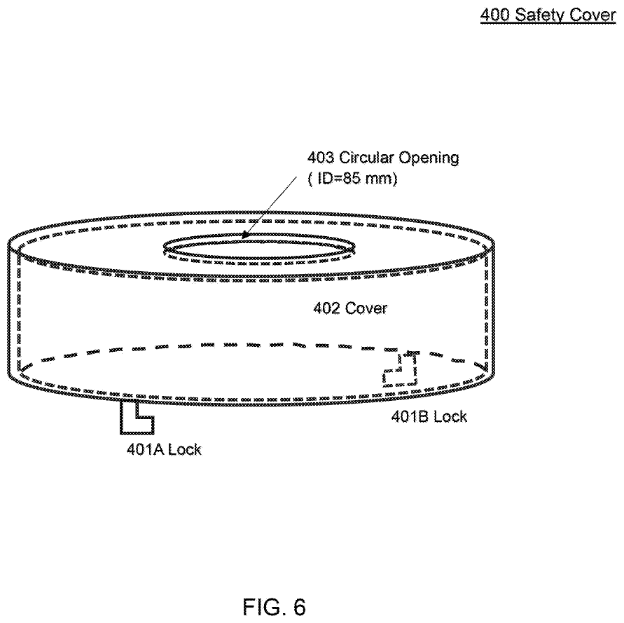

FIG. 6 shows an exemplary configuration of the safety cover (400) having a circular opening (403) on the top and two locks (401A and 401B) at the bottom to secure it with the top edge of the food container (200). The circular opening has a diameter the same as (e.g., 85 mm) or a few millimeters smaller (e.g., 83 mm) than the inner diameter (e.g., 85 mm) of the kernel stripper. The outer diameter of the kernel stripper is larger (e.g., 90 mm). In this way, an ear of corn can get into the kernel stripper without any obstacle. When the safety cover is locked with the food container, there is a tiny gap (e.g., 2 mm) between the top of the kernel stripper and the inner top surface of the safety cover. The design ensures that the stripper does not touch the safety cover during operation (as it is further pressured down about 3 mm) and is held in place by the cover while retrieving a cob after stripping the kernels. The safety cover can be made of materials such as food-grade plastic (e.g., grade 2, 4, and 5) or food-grade stainless steel (e.g., 304, 316), etc.

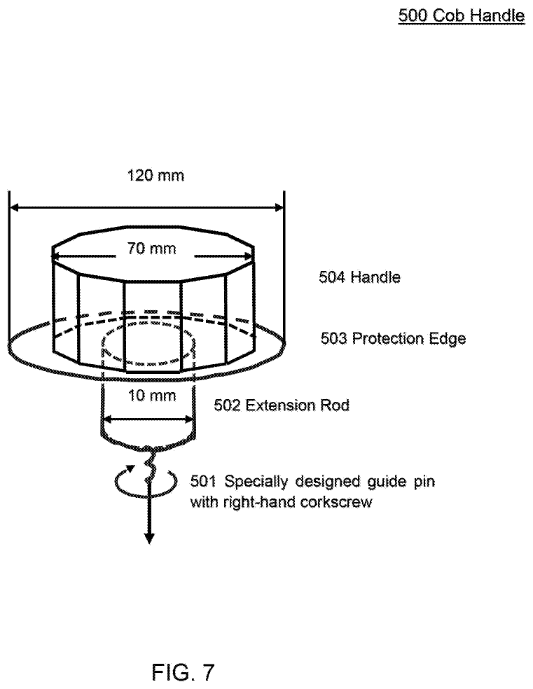

FIG. 7 shows a 3-D view of an exemplary cob handle (500) having a specially designed guide pin with a corkscrew (501), an extension rod (502), a protection edge (503), and a handle (504). The cob handle is designed to handle it safely. For example, the specially designed guide pin consists of a long straight pin (e.g., 60 mm in length and 3 mm in diameter) at the bottom and just a few threads like a corkscrew (e.g. one or two) on the top. The long pin enables it to insert into a cob straightly and a few threads enable it to fasten into a cob quickly. Furthermore, the direction of the threads (e.g., right-handed threads) is chosen so that the rotation of the motor adaptor (e.g., right-hand rotation) and the kernel stripper (e.g., right-hand rotation) only tightens it during the stripping. These designs ensure that an ear of corn can be attached to or removed from the cob handle quickly but without becoming loose during the stripping and retrieving of the cob. The extension rod acts as a stopper for the cob and ensures the end of the cob can pass through the saw at the top of the blades but does not pass through the bottom of them. It has a diameter (e.g., 10 mm) much smaller than the minimum diameter (e.g., 30 mm) of blades so it will not touch the blade set. A proper length (e.g., 30 mm) is chosen so that the protection edge on the cob handle will contact the top of the safety cover and stop the downward movement before the extension rod passes through the bottom of the cylindrical blade set. The protection edge has a diameter (e.g., 120 mm) much larger than the circular hole (e.g., 85 mm) in the safety cover. For example, the diameter of the handle (e.g., 70 mm) is chosen for conveniently holding the handle for most people. The shape of the handle can be like a prism (e.g., dodecagon prism) or a cylinder with grooves, which helps to reduce the slipperiness during the handling. The specially designed guide pin can be made of material like food-grade stainless steel (e.g., 304, 316) and the rest parts can be food-grade plastic (e.g., grade 2, 4, and 5).

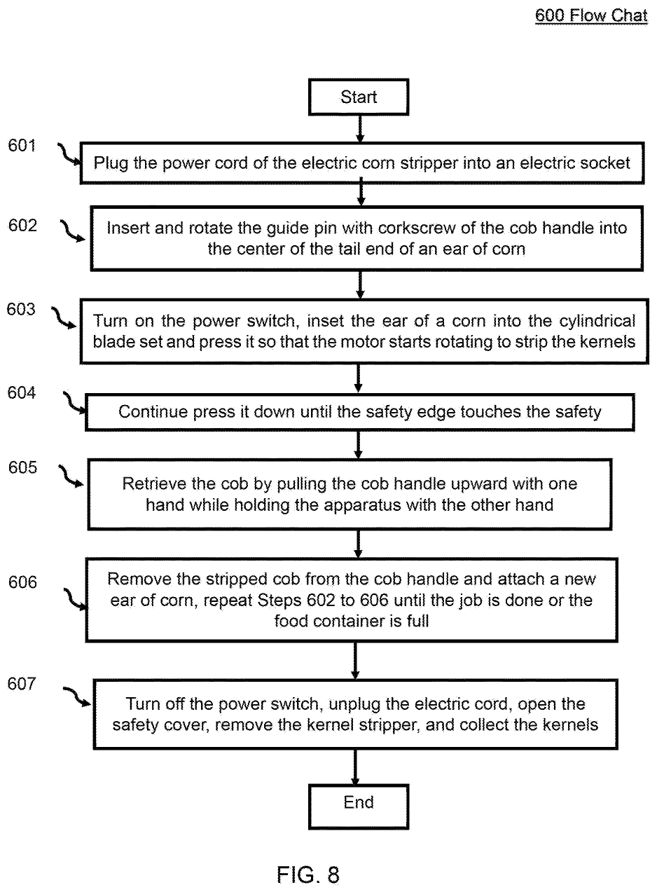

FIG. 8 is an exemplary workflow showing the steps of using the self-adaptive electric corn stripper to separate kernels from cobs. In Step 601, the power cord of the stripper is plugged into an electric socket. In Step 602, an ear of corn is attached to the cob handle by inserting and rotating the guide pin with a corkscrew into the center of the tail end. In Step 603, the power is turned on and the ear of corn is pressed into the center of the kernel stripper and the motor starts rotating to strip the kernels. In Step 604, the press down is continued until the safety edge of the cob handle touches the safety cover. In Step 605, the stripped cob is retrieved by pulling the cob handle upward while holding the apparatus. In Step 606, a new ear of corn is attached to the cob handle after the stripped cob is removed, and Steps 602 to 606 are repeated until the job is done or the food container is full. In Step 607, the kernels are collected after the power switch is turned off, the electric cord is unplugged, and the safety cover and the kernel stripper are disassembled.

While in the foregoing specification this disclosure has been described in relation to certain preferred embodiments thereof, and many details have been set forth for the purpose of illustration, it will be apparent to those skilled in the art that the disclosure is susceptible to alteration and that certain other details described herein can vary considerably without departing from the basic principles of the disclosure. In addition, it should be appreciated that structural features or methodologies shown or described in any one embodiment herein can be used in other embodiments as well.

1. An apparatus configured to separate corn kernels from a cob, the apparatus comprising:
a motor unit;
a food container configured to receive the separated kernels;
a kernel stripper operably coupled to the motor unit;
a safety cover configured to obstruct manual contact with the kernel stripper and to retain the kernel stripper during removal of the cob; and
a cob handle configured to engage the cob during a stripping operation.

2. The apparatus of claim 1, wherein the motor unit is configured to receive power from at least one of an AC power source, a DC power source, or a rechargeable battery.

3. The apparatus of claim 1, wherein the motor unit further comprises a voltage converter and an electronic control system.

4. The apparatus of claim 1, wherein the food container is constructed from a food-grade stainless steel or a food-grade plastic.

5. The apparatus of claim 1, further comprising a rotor connector and a rotor adapter, wherein the kernel stripper is coupled to the motor unit via the rotor connector and the rotor adapter, and wherein the rotor adapter includes a compressible safety switch.

6. The apparatus of claim 5, wherein the compressible safety switch is positioned beneath the rotor adapter and is configured to activate the motor unit upon a downward pressure on the rotor adapter,

7. The apparatus of claim 1, wherein the kernel stripper comprises a cylindrical blade set including a plurality of spring-biased curved blades.

8. The apparatus of claim 7, wherein the kernel stripper further comprises a side wall and a base, and wherein a plurality of apertures is disposed through the side wall and the base.

9. The apparatus of claim 7, wherein the plurality of spring-biased curved blades and a plurality of springs are constructed from a food-grade stainless steel or titanium, and wherein a body of the kernel stripper is constructed from a food-grade stainless steel, titanium, or food-grade plastic.

10. The apparatus of claim 7, wherein a rotation direction of the cylindrical blade set is the same as a rotation direction of the kernel stripper, wherein the rotation direction is selected from a right-hand rotation and a left-hand rotation.

11. The apparatus of claim 7, wherein the plurality of spring-biased curved blades are configured to adjust radially to accommodate corn cobs of varying diameters.

12. The apparatus of claim 1, wherein a rotational speed of the kernel stripper is regulated within a range configured for kernel stripping.

13. The apparatus of claim 1, further comprising at least one lock configured to secure the motor unit, the food container, and the safety cover together.

14. The apparatus of claim 1, wherein the cob handle comprises a handle portion, a protection edge, an extension rod, and a guide pin having a corkscrew with a plurality of screw threads.

15. The apparatus of claim 14, wherein a rotation direction of the plurality of screw threads of the corkscrew in the cob handle is the same as a rotation direction of the kernel stripper, wherein the rotation direction is selected from a right-hand rotation and a left-hand rotation.

16. The apparatus of claim 14, wherein the safety cover defines a circular hole having a diameter smaller than a diameter of the protection edge of the cob handle.
